(19) United States
(12) Patent Application Publication
(10) Pub. No.: US 2007/0234966 A1
(43) Pub. Date: Oct. 11, 2007

(54) Cat litter box cabinet system

(76) Inventor: Paul Pettys, Rock Hill, SC (US)

Correspondence Address: Clifford Kraft, 320 Robin Hill Dr., Naperville, IL, 60540, US

(21) Appl. No.: 11/710,850

(22) Filed: Feb. 26, 2007

Related U.S. Application Data
(63) Continuation-in-part of application No. 11/144,562, filed on Jun. 3, 2005, now abandoned.

(51) Int. Cl. A01K 29/00

(52) U.S. Cl. 119/165

(57) ABSTRACT

A cat litter containment enclosure system with four walls that locates a litter container at an elevated level preferably on a shelf where a cat enters the enclosure from a port in a front panel and hops or jumps to a second level for access to a litter container. The enclosure can contain a second pad located on the second level near the litter container so that the cat's paws are cleaned as the cat exits the enclosure. The top and front panel of the enclosure can be hinged for easy access for cleaning and/or inspection. Translucent vent holes can also be supplied on the enclosure for air and light.

This is a continuation-in-part of co-pending application Ser. No. 11/144,562 filed Jun. 3, 2005. Application Ser. No. 11/144,562 is hereby incorporated by reference.

### BACKGROUND

1. Field of the Invention

The present invention relates to the general field of pet waste disposal and more particularly to a self-contained litter box cabinet system.

2. Description of the Prior Art

Litter boxes are well-know methods of handling the problem of indoor cat waste. The classical problem with a litter box is that it is usually in the open and is therefore accessible to children and other household pets. In addition, there may be unpleasant odors associated with an open litter box.

Another problem with an open litter box is that cats normally track particles out of the litter box when they leave or thrash and throw out particles. These particles can be particularly damaging to floors and the like as well as creating the possibility of spreading unwanted cat-waste into the house.

Cat owners who also own dogs are aware that dogs tend to eat cat waste from an open litter box. This can cause the dog to become sick.

Baille et al. in U.S. Pat. No. 5,092,277 teach a cat litter containment system which includes a closed housing. Ballie's system uses a screen that the cat must walk down to clean the cat's paws.

Baille et al. in U.S. Pat. No. 5,361,725 teach a carryable enclosure where a cat walks across a screen before reaching a litter box.

The applicant, in a prior system, taught a closed box with two doors that had a litter box on a second shelf recessed into the shelf. A small opening appeared in one of the doors. The entire assembly was raised with a “kick” along the front bottom. The door did not come down all the way to the floor.

Nowhere in the prior art is the problem of an out of sight litter box solved where the litter box material cannot be thrown out of the enclosure and cat can walk on a solid flat surface on its way to and from the litter box, and where a larger and older cats can be accommodated.

### SUMMARY OF THE INVENTION

The present invention relates to a cat litter containment enclosure system with four walls that locates a litter container at an elevated level preferably on a shelf where a cat can enter the enclosure from a port on the ground level in a front panel, walk on a pad, preferably of ASTROTURF (ASTROTURF is a registered trademark of Astroturf Industries, Inc.) or similar material, then hop or jump up to the a second level to reach a litter container. The enclosure can contain an optional second pad located on the second level where the litter container is located so that the cat's paws are cleaned as the cat exits the enclosure. The top and front panel of the enclosure can be hinged for easy access for cleaning and/or inspection. The present invention allows the litter container to be out of sight to prevent scattering of litter material onto floors, eating of cat-waste by dogs and propagation of undesired odors. The size of the opening helps keep dogs and children out of the unit. The door of the present invention is at floor level and large enough to accommodate larger cats. The litter container is on a shelf low enough that older cats can make the jump.

### DESCRIPTION OF THE FIGURES

FIG. 1 shows a front perspective view of an embodiment of the present invention.

FIG. 2 shows the embodiment of FIG. 1 with the top open.

FIG. 3 shows the embodiment of FIGS. 1-2 with the front door open.

FIG. 4 is a top down view.

FIG. 5 is a sectional side view.

FIG. 6 is a perspective view of an improved embodiment of the present invention where the door comes down floor level.

FIG. 7 is a back view of the embodiment of FIGS. 6-7.

Several illustrations and drawings have been presented to aid in the understanding of the present invention. The scope of the present invention is not limited to the figures.

### DESCRIPTION OF THE INVENTION

The present invention relates to an “out of sight” cat litter box that solves the problems of litter being spread on floors, dogs eating cat wastes, odors and the like.

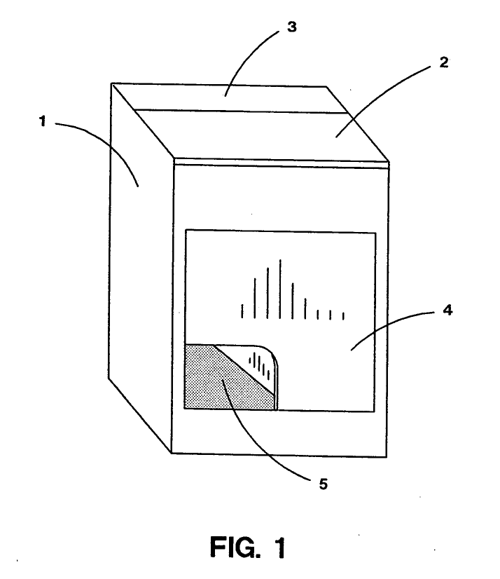

FIG. 1 shows a perspective view of an embodiment of the present invention. An enclosure 1 contains a 2-part top with a fixed part 3 and a part that can be opened 2. The front of the enclosure 1 has a door 4 with an opening that a cat can enter. A cat learns that to use the litter system, it must enter through the opening into the enclosure, and then hop or jump up to a second level.

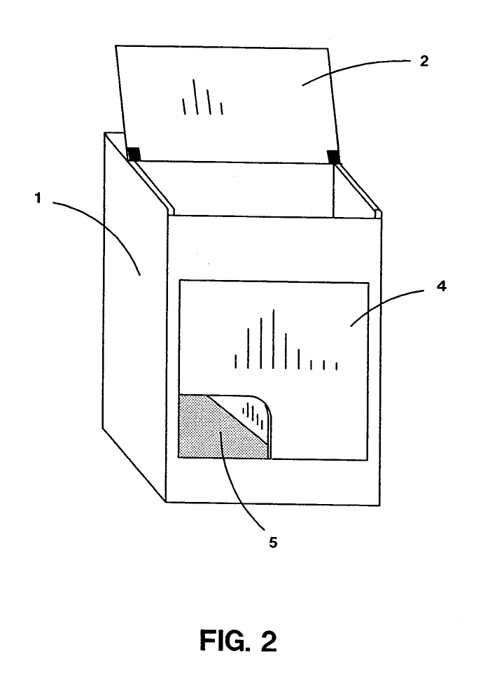

FIG. 2 shows the embodiment of FIG. 1 with the lid 2 open. Opening this lid 2 allows the cat owner to access the litter container that is located in the upper part of the device. The access lid 2 can be attached to the fixed part 3 by a pair of hinges or by any other attachment device or method.

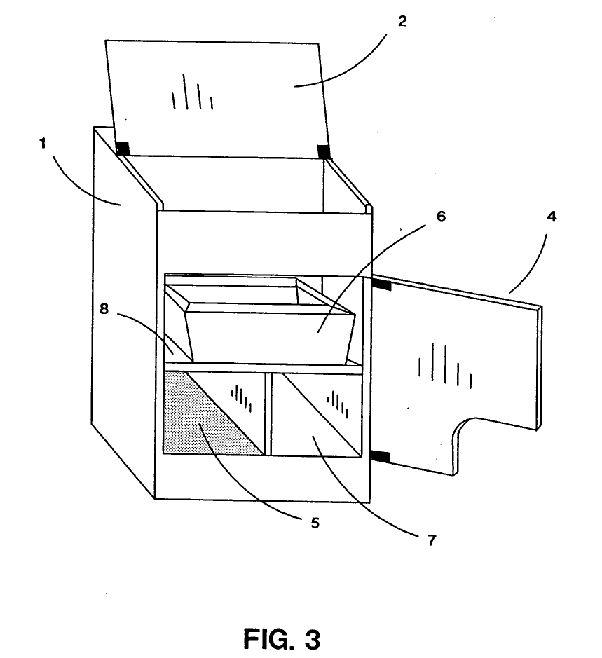

Turning to FIG. 3, the embodiment of the present invention is seen with both the lid 2 and the front door 4 open. The entrance with a pad 5 can be clearly seen. The cat must walk through the padded entrance to reach the litter container 6 that is located on the upper level. The preferred size litter container is around 15×19 inches; however, any size container is within the scope of the present invention. The act of walking on the pad 5 cleans the paws of the cat. An extra compartment 7 can be seen in FIG. 3 which can be used to store accessories or anything else. The litter container 6 can rest on a shelf 8.

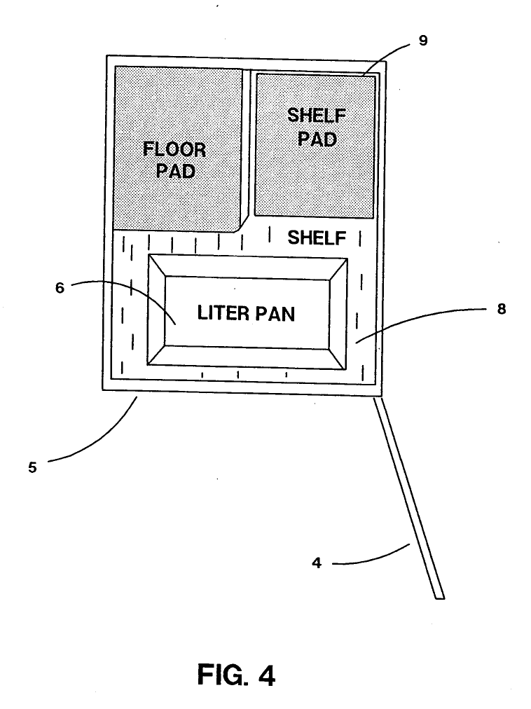

FIG. 4 shows a top-down view of the embodiment of FIG. 1 with the lid not shown. The shelf 8 can hold a litter container 6 (shown in FIG. 3). The padded entrance 5 where the cat hops or jumps to a second level shelf 8. The cat merely jumps from the second level pad 9 into the litter box 6. When the cat is finished, it jumps back onto the second level pad 9 and then jumps to the first level pad 5 to exit the enclosure 1. By walking across the pads 9, 5, the cat's paws are cleaned so that litter is not tracked out of the enclosure into the house.

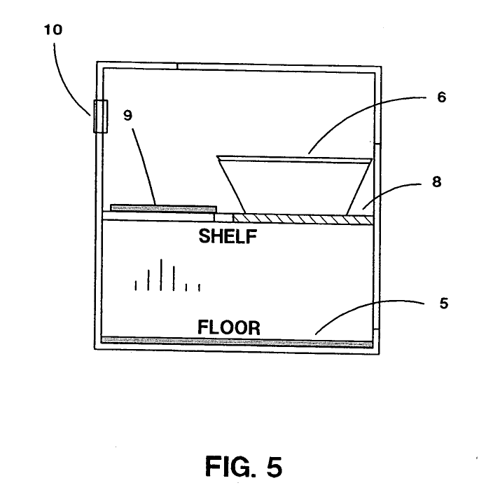

FIG. 5 shows a sectioned side view of the embodiment of FIG. 4. The entrance pad 5 can be clearly seen leading into the cabinet from where the cat hops or jumps to the second level pad 9 which is located on the shelf 8. The litter box 6 also rests on the shelf 8. The cat walks into the entrance, jumps to the second level shelf and into the litter box. The back panel of the enclosure 1 can have optional ventilation holes.

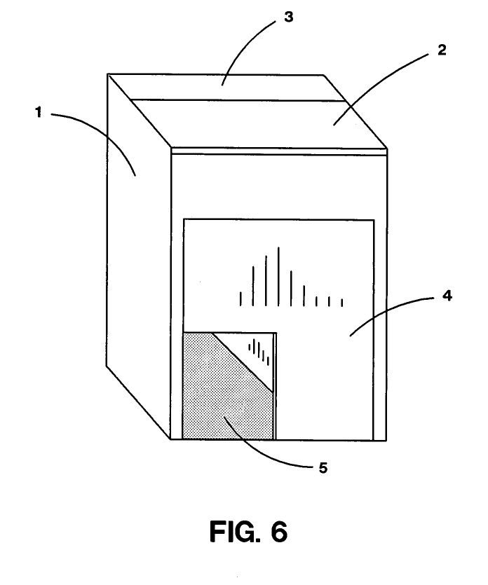

FIG. 6 shows an improved embodiment of the present invention. One of the problems with the prior art and the previous embodiments herein described is that larger cats may not be able to get into a small doorway. Also, the other embodiments had the bottom of the door around 6 inches above the floor requiring the cat to hop in. The embodiment of FIG. 6 has a door that is flush with the floor allowing the cat to simply walk in. The door size has been increased from around 6×8 inches to around 10×10 inches to accommodate larger cats. While this is the preferred door size, any door size with within the scope of the present invention. In this embodiment, the shelf has been lowered from around 17 inches to around 10 inches. This allows older cats to make the jump as well as younger cats. While this is a preferred height for the shelf, any height is within the scope of the present invention. It can be seen that in this embodiment, the litter pan has been made smaller, and in both embodiments, that it sits on the shelf rather than being recessed into the shelf. This structure gives the shelf more strength. Optionally, the front edge of the structure can contain a dip that prevents the lid from smashing fingers if it falls.

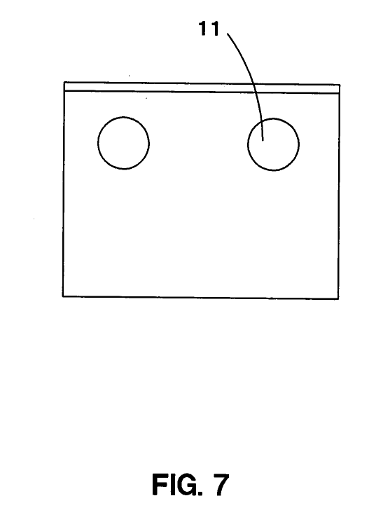

FIG. 7 shows a rear view of the embodiments of FIG. 6. One or more translucent vents 11 can be seen. These optional vents allow air to circulate into the enclosure and allow light to enter so that it is not dark inside.

The cat litter cabinet system of the present invention can be made from any convenient material. The preferred material is any form of wood or plastic. Hinges, or any other fasteners, can be used to allow the lid and door to open. The padding on the first and second level can be ASTROTURF, or any other convenient padding material. The entrance hole can be made large enough to accommodate a large cat. Dogs will normally not try to enter into the small enclosure. The litter box is easily cleaned and filled from the top, and the entire unit is accessible for cleaning and inspection from the front.

Several descriptions and illustrations have been presented to better aid in understanding the present invention. A person of skill in the art will recognize that many changes and variations are possible. All such changes and variations are within the scope of the present invention.

I claim:

1. A cat litter containment system comprising:
an enclosure, said enclosure having two side walls, a back wall, a floor and a lid, said lid being hinged and openable for top access to said litter containment system, said enclosure also having a lower part and an upper part, the upper part being formed by a partial horizontal shelf upon which a cat litter container is disposed and positioned so that the cat can hop or jump to reach it;
a front door to said enclosure, said front door comprising a floor-level access port for entering said enclosure, wherein an area on said floor adjacent to the access port contains a pad;
at least one translucent vent in said back wall, said translucent vent allowing both air and light to enter said enclosure.

2. The cat litter containment system of claim 1 wherein said shelf is around 10 inches above said floor.

3. The cat litter containment system of claim 1 wherein said access port is around 10×10 inches.

4. The cat litter containment system of claim 1 wherein said lid is hinged to said side walls a distance from said back wall.

5. The cat litter containment system of claim 1 wherein said horizontal shelf also includes a pad.

6. The cat litter containment system of claim 1 wherein said enclosure is wood.

7. A cat litter box enclosure comprising:
a generally rectangular 3-dimensional box having side walls and a rear wall, floor and hinged lid, said box having a front part and a rear part, said box also having a shelf located in said front part at a level dividing said box into an upper part and a lower part;
a single front door closing said box, said front door having a ground-level entrance port for entry into the lower part of said box;
a padded area in the front part of said box adjacent to said entrance port;
a shelf on said upper part such that a cat can enter said entrance port, and can hop or jump to said shelf to access a litter container disposed on said shelf;
a pad disposed on said shelf for cleaning a cat's paws;
at least one translucent vent in said rear wall, said vent passing both air and light into said enclosure.

7. The cat litter box enclosure of claim 6 wherein said entrance port is an opening in said single front door.

8. The cat litter box enclosure of claim 7 wherein said opening is around 10×10 inches.

9. The cat litter box enclosure of claim 6 wherein said shelf is around 10 inches above the floor.

10. The cat litter box enclosure of claim 6 wherein said hinged lid includes hinges located near the rear wall of said box.

11. The cat litter box enclosure of claim 6 wherein said single front door is hinged to said box.

12. The cat litter box enclosure of claim 6 wherein said hinged lid moves between a closed position and a partially open position, said lid being supported by the rear wall of said box when in the partially open position.

13. The cat litter box enclosure of claim 6 further comprising at least one extra compartment in said box.

14. A cat litter enclosure of the type holding a litter container wherein a cat can enter a door at ground level by walking in, and where the door is around 10×10 inches, the enclosure containing a shelf around 10 inches above the ground level, and where the cat can jump from the ground level to the shelf to find the litter container on the shelf, the cat crossing a section of pad material between the door and a point interior to the enclosure where the cat can jump to the shelf, the enclosure also containing at least one translucent vent for passing both air and light into the enclosure.

15. The cat litter enclosure of claim 14 further including a second pad on said shelf.

16. The cat litter enclosure of claim 14 wherein said enclosure is wood.

17. The cat litter enclosure of claim 14 further including a hinged lid.

18. The cat litter enclosure of claim 14 wherein the door is in a front cover, the front cover being hinged on one side.
